(19) United States
(12) Patent Application Publication
(10) Pub. No.: US 2015/0195214 A1
(43) Pub. Date: Jul. 9, 2015

(54) VERIFICATION METHOD, VERIFICATION DEVICE, AND RECORDING MEDIUM

(71) Applicant: FUJITSU LIMITED, Kawasaki-shi, Kanagawa (JP)

(72) Inventors: Taichi Sugiyama, Kawasaki (JP); Takeshi Yasuie, Kawasaki (JP); Yuji NOMURA, Kawasaki (JP)

(21) Appl. No.: 14/573,623

(22) Filed: Dec. 17, 2014

(30) Foreign Application Priority Data
Jan. 6, 2014 (JP) 2014-000654

(51) Int. Cl. H04L 12/911; H04L 12/24; G06F 17/30

(52) U.S. Cl. CPC H04L 47/70; G06F 17/30091; H04L 41/145

(57) ABSTRACT

A verification method includes storing a plurality of cache scenarios in which combinations of one or more data which are a caching object are defined, the caching object indicating an object to be stored in a first server whose processing speed is faster than that of a second server, the combinations being different from each other; acquiring a plurality of packets related to a request for data; estimating, by a processor, response time, which is response time to the request when using both the first server and the second server together for processing the plurality of packets, the response time corresponding to each of one or more cache scenarios among the plurality of cache scenarios, based on the plurality of acquired packets; and specifying a cache scenario which satisfies a predetermined threshold among the one or more cache scenarios based on the estimated response time.

### CROSS-REFERENCE TO RELATED APPLICATION

This application is based upon and claims the benefit of priority of the prior Japanese Patent Application No. 2014-000654, filed on Jan. 6, 2014, the entire contents of which are incorporated herein by reference.

### FIELD

The embodiments discussed herein are related to a verification method, a verification device, and a recording medium.

### BACKGROUND

When transmitting and receiving multiple data between servers which configure a system, it takes time to access a hard disk drive in the server while a cache memory in the server does not have a sufficient capacity. Thus, a method of installing a cache server has been used.

For example, the server reduces time for reading data by changing a destination where each of data is cached, such that data A is stored in a cache memory, data B is stored in a cache server, and the like. As a related art, for example, Japanese Laid-open Patent Publication No. 4-182755, Japanese Laid-open Patent Publication No. 2004-139366, Japanese Laid-open Patent Publication No. 2000-29765, and the like are disclosed.

However, whether or not an expected effect is obtained by introducing the cache server into a system depends on a system configuration or a type of data to be cached, so that it is difficult even for a system administrator to make a determination.

### SUMMARY

According to an aspect of the invention, a verification method includes storing a plurality of cache scenarios in which combinations of one or more data which are a caching object are defined, the caching object indicating an object to be stored in a first server whose processing speed is faster than that of a second server, the combinations being different from each other; acquiring a plurality of packets related to a request for data; estimating, by a processor, response time, which is response time to the request when using both the first server and the second server together for processing the plurality of packets, the response time corresponding to each of one or more cache scenarios among the plurality of cache scenarios, based on the plurality of cache scenarios and the plurality of acquired packets; and specifying, by the processor, a cache scenario which satisfies a predetermined threshold among the one or more cache scenarios based on the estimated response time.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an entire configuration example of a system according to Embodiment 1;

FIG. 2 is a functional block diagram illustrating a functional configuration of a verification server according to Embodiment 1;

FIG. 3 is a table illustrating an example of information stored in a scenario DB;

FIG. 4 is a diagram illustrating a calculation of theoretical values under an environment in which there is an interconnection between devices;

FIG. 5 is a diagram illustrating the calculation of the theoretical values under an environment in which there is no interconnection between devices;

FIG. 6 is a diagram illustrating a calculation of verified values;

FIG. 7 is a diagram illustrating a cache effect;

FIG. 8 is a table illustrating an example of scenario selection in which the cache effect can be maximized;

FIG. 9 is a table illustrating an example of scenario selection in which the cache effect is large when AP is improved;

FIG. 10 is a table illustrating an example of scenario selection with suppressed cost;

FIG. 11 is a table illustrating an example of an optimal scenario selection regardless of cost;

FIG. 12 is a flow chart illustrating a flow of verification processing according to Embodiment 1;

FIG. 13 is a flow chart illustrating a flow of scenario generation processing according to Embodiment 2;

FIG. 14 illustrates tables which describe detailed example 1 of the scenario generation according to Embodiment 2;

FIG. 15 illustrates tables which describe detailed example 2 of the scenario generation according to Embodiment 2;

FIG. 16 illustrates tables which describe detailed example 3 of the scenario generation according to Embodiment 2;

FIG. 17 is a diagram illustrating a system configuration example when an operating system is installed on a physical server and a verification system is realized on a virtual machine;

FIG. 18 is a diagram illustrating a system configuration example when an operating system is realized on a virtual machine and a verification system is installed on a physical server;

FIG. 19 is a diagram illustrating a system configuration example when an operating system and a verification system are realized using a virtual machine on different physical servers;

FIG. 20 is a diagram illustrating a system configuration example when an operating system and a verification system are realized using a virtual machine on the same physical server;

FIG. 21 is a diagram illustrating an estimate of a memory capacity of a cache server; and

FIG. 22 is a diagram illustrating a hardware configuration example.

### DESCRIPTION OF EMBODIMENTS

Hereinafter, embodiments of a verification program, a verification device, and a verification method disclosed in the present application will be described in detail based on drawings. The present application is not limited by the embodiments. Each of the embodiments can be appropriately combined in a range without contradiction.

### Embodiment 1

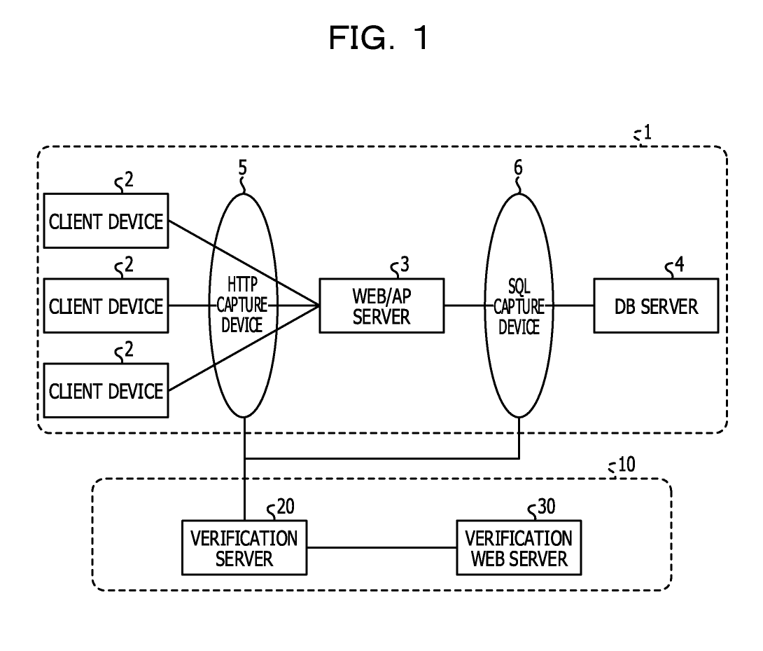

FIG. 1 is a diagram illustrating an entire configuration example of a system according to Embodiment 1. As illustrated in FIG. 1, the system includes an operating system 1 and a verification system 10.

The operating system 1 includes a plurality of client devices 2, a Web/AP server 3, a DB server 4, a Hyper Text Transfer Protocol (HTTP) capture device 5, and a Structured Query Language (SQL) capture device 6.

The plurality of client devices 2 are devices which access the Web/AP server 3, and execute a Web service or an application. The client device 2 is, for example, a personal computer, a smart phone, a portable terminal, and the like. For example, the client device 2 transmits an HTTP request to the Web/AP server 3, and receives a response to the request from the Web/AP server 3.

The Web/AP server 3 is a server device which provides a Web service or an application. The Web/AP server 3 executes processing in response to a request from the client device 2, writes requested data in a DB server 4, and reads the requested data from the DB server 4. For example, the Web/AP server 3 issues SQL statements in the DB server 4, and executes the reading and writing of data.

The DB server 4 is a data-base server which stores data. The DB server 4 executes the SQL statements received from the Web/AP server 3, executes reading and writing of data, and responds to the Web/AP server 3 with the result.

The HTTP capture device 5 is a device which captures an HTTP request transmitted from the client device 2 to the Web/AP server 3 and an HTTP response transmitted from the Web/AP server 3 to the client device 2. For example, the HTTP capture device 5 can use a network tap, port mirroring of a switch, and the like.

The SQL capture device 6 is a device which captures SQL statements transmitted from the Web/AP server 3 to the DB server 4 and a SQL response transmitted from the DB server 4 to the Web/AP server 3. For example, the SQL capture device 6 can use a network tap, port mirroring of a switch, and the like.

The verification system 10 includes a verification server 20 and a verification Web server 30. The verification Web server 30 is a server which is created for verification, and has the same function as the Web/AP server 3.

The verification server 20 is a server device which executes processing of a cache server in a pseudo manner, and verifies a data response and the like when the cache server is introduced into an operating system 1. The verification server 20 is coupled to the HTTP capture device 5 and the SQL capture device 6.

For example, the verification server 20 acquires packets which are transmitted or received in the operating system 1 and relate to a request for data, and accumulates the packets. Then, the verification server 20 estimates response time to a request for data to be cached when the cache server is introduced, using the accumulated packets in each cache scenario in which data to be cached are defined. Then, the verification server 20 specifies a cache scenario which satisfies system requirements when the cache server is introduced, based on the response time in each estimated cache scenario.

In this manner, the verification server 20 specifies a scenario which has shorter response time when applying one of a plurality of scenarios in which data to be cached are defined to data captured in an actual environment than a response time in the actual environment. Therefore, it is possible to determine an effect caused by introduction of a cache server.

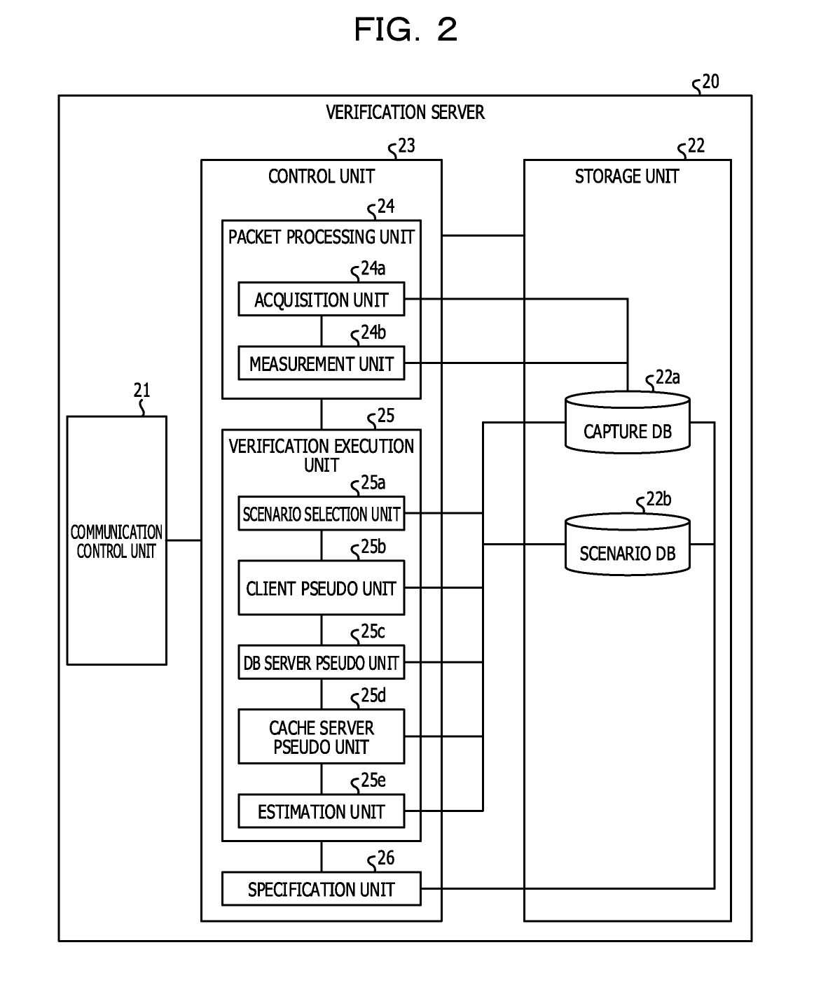

FIG. 2 is a functional block diagram illustrating a functional configuration of the verification server according to Example 1. The Web/AP server 3 has the same function as a general Web server or application server, and the DB server 4 has the same function as a general DB server, so that a detailed description is omitted. As illustrated in FIG. 2, the verification server 20 includes a communication control unit 21, a storage unit 22, and a control unit 23.

The communication control unit 21 is a processing unit which controls communication with other server devices. The communication control unit 21 is, for example, a network interface card, and the like. For example, the communication control unit 21 is coupled to the HTTP capture device 5 to receive an HTTP request or an HTTP response captured by the HTTP capture device 5. The communication control unit 21 is coupled to the SQL capture device 6 to receive a SQL statement or a SQL response captured by the SQL capture device 6.

The storage unit 22 is a storage device which stores a program to be executed by the control unit 23 or various types of data. The storage unit 22 is, for example, a semiconductor memory, a hard disk, and the like. The storage unit 22 includes a capture DB 22a and a scenario DB 22b.

The capture DB 22a is a database which stores a packet captured in the operating system 1. Specifically, the capture DB 22a stores a packet which is exchanged between respective devices of the operating system 1 and relates to a request for reading and writing of data.

For example, the capture DB 22a stores packets which are transmitted or received with respect to a series of requests that are made of an HTTP request from the client device 2 to the Web/AP server 3, a SQL statement from the Web/AP server 3 to the DB server 4, a SQL response from the DB server 4 to the Web/AP server 3, and an HTTP response from the Web/AP server 3 to the client device 2.

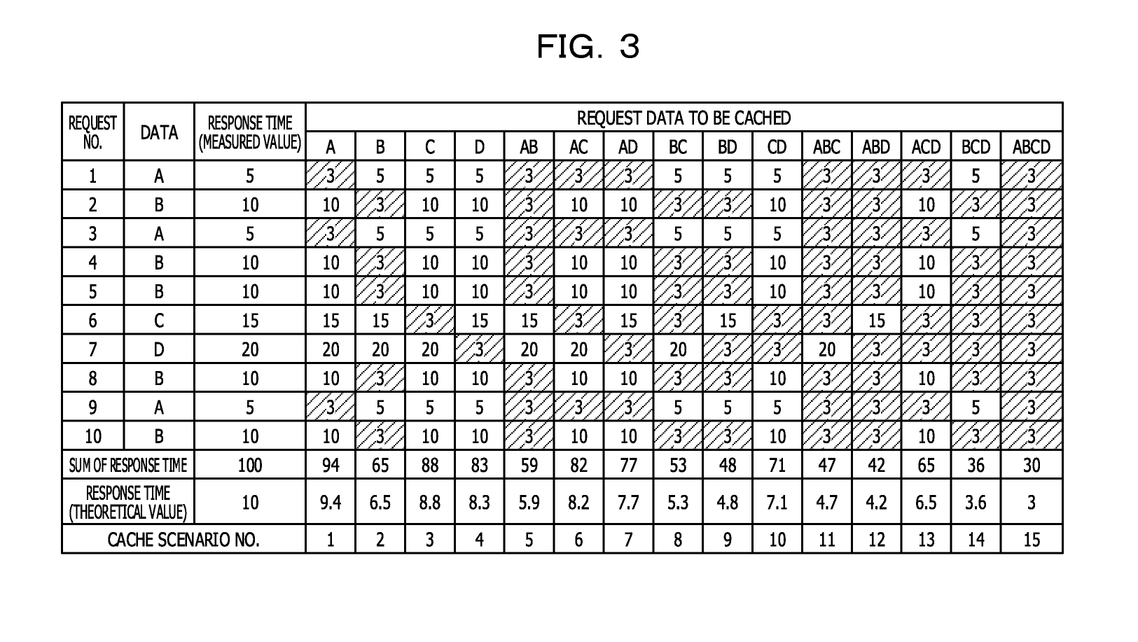

The scenario DB 22b is a database which stores a cache scenario defining data to be cached. The scenario DB 22b stores a scenario for determining what effect is obtained depending on data to be cached. FIG. 3 is a diagram illustrating an example of information stored in the scenario DB.

As illustrated in FIG. 3, the scenario DB 22b stores “request number, data, response time (measured value), and request data to be cached” in correlation with each other. “Request No.” stored herein indicates an order of requests occurring in the operating system 1. “Data” indicates data requested by the requests. “Response time (measured value)” is time between when the requests occur and when a response is sent back, and is information captured in the operating system 1. “Request data to be cached” indicates data to be captured when performing verification in a verification environment.

FIG. 3 illustrates that ten data are packet-captured in an order of data A, B, A, B, B, C, D, B, A, and B, and measured values of response time are 5, 10, 5, 10, 10, 15, 20, 10, 5, 10 ms in order. Since a sum of the response time is 100 ms and the number of data is ten, an average value of response time per data is 10 ms.

As data to be cached, A, B, C, D, AB, AC, AD, BC, BD, CD, ABC, ABD, ACD, BCD, and ABCD are set. Then, cache scenarios are set from 1 to 15 in order. For example, data A to be cached is defined in a cache scenario No. 1. This indicates that data A is cached in the cache server. Data A and data C are defined in a cache scenario No. 6 as data to be cached. This indicates that data A and data C are cached in the cache server. Data B, data C, and data D are defined in a cache scenario No. 14 as data to be cached. This indicates that data B, data C, and data D are cached in the cache server.

A theoretical value of response time to each request number of data is set in each cache scenario. For example, in the cache scenario No. 1 in which data A is cached, 3 ms is set for data A of request No. 1, 10 ms is set for data B of request No. 2, and 3 ms is set for data A of request No. 3. Moreover, 10 ms is set for data B of request no. 4 and data C of request no. 5, 15 ms is set for data C of request no. 6, and 20 ms is set for data D of request no. 7. 10 ms is set for Data B of request no. 8, 3 ms is set for data A of request no. 9, and 10 ms is set for data B of request no. 10. Furthermore, since a sum of theoretical values of response time in the cache scenario no. 1 is 94 ms and the number of data is ten, an average value of response time per data is 9.4 ms.

Since the cache scenario No. 1 is a scenario in which data A is cached, a theoretical value of data A is shorter than a measured value. Then, measured values of the other data are the same as theoretical values. In the same manner, since a cache scenario no. 7 is a scenario in which data A and data D are cached, theoretical values of data A and data D are shorter than measured values thereof. Then, measured values of the other data are the same as theoretical values thereof. This indicates that response time is reduced since data to be cached are read not from the DB server 4 but from the cache server.

Here, calculation of theoretical values will be described with an example of a case where data B is cached. As an example, it is described that time for reading data using the cache server is 1 ms. Processing to be executed herein is executed by a control unit 23 to be described below.

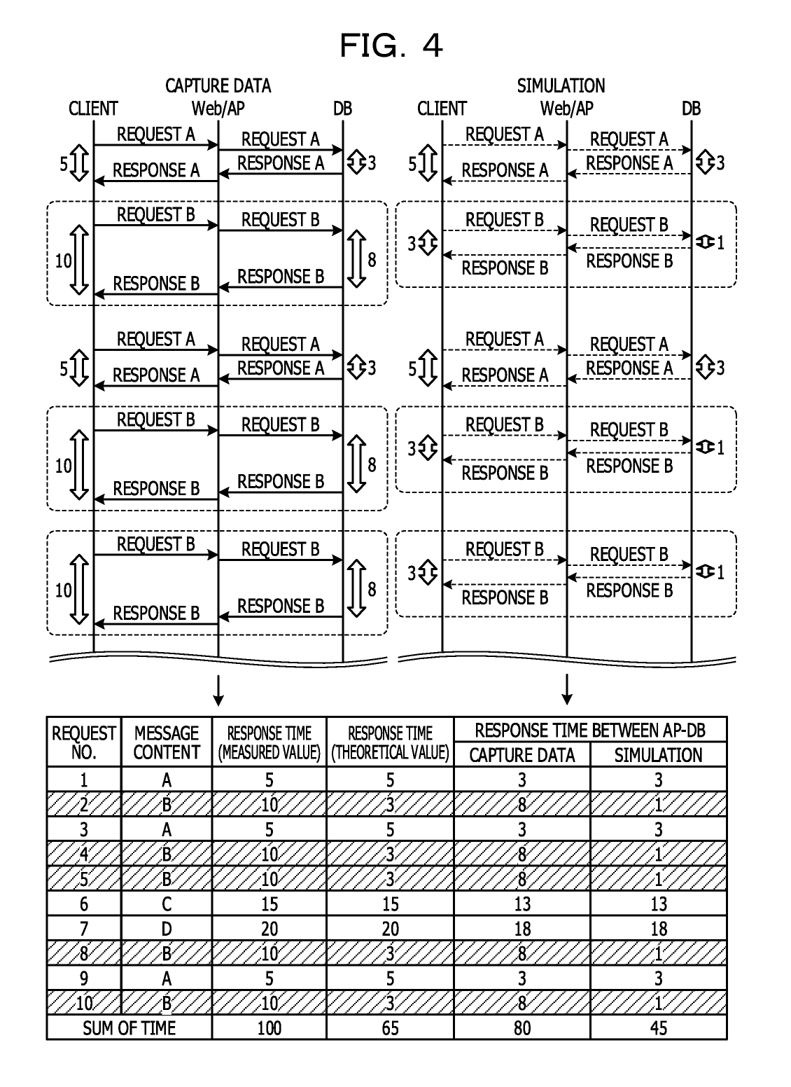

FIG. 4 is a diagram illustrating a calculation of theoretical values under an environment in which there is an interconnection between devices. That is, there is an interconnection among the client device 2, the Web/AP server 3 and the DB server 4. As illustrated in FIG. 4, the calculation of theoretical values is described with an example in which data A, data B, data A, data B, and data B are sequentially captured. At a request of respective data, a request from the client device 2 to the Web/AP server 3, a request from the Web/AP server 3 to the DB server 4, a response to the Web/AP server 3 from the DB server 4, and a response to the client device 2 from the Web/AP server 3 are executed.

First, the captured data will be described. At a request for data A at the beginning, it takes 3 ms to read data from the DB server 4, and then it takes 5 ms for the client device 2 to receive response A after making request A. At a request for next data B, it takes 8 ms to read data from the DB server 4. Then, it takes 10 ms for the client device 2 to receive response B after making request B.

At a third request of data A, it takes 3 ms to read data from the DB server 4. Then, it takes 5 ms for the client device 2 to receive response A after making request A. At fourth and fifth requests of data B, it takes 8 ms to read data from the DB server 4. Then, it takes 10 ms for the client device 2 to receive response B after making request B.

In a state of being captured in this manner, a theoretical value of response time to a request when data reading time using the cache server is 1 ms will be described. First, since an initial request for data A is not data to be cached and takes the same time as in capturing data, a measured value becomes the same as a theoretical value.

Then, at a second request of data B, since data B is data to be cached, time for reading data from the DB server 4 is reduced to be 1 ms of a theoretical value. Thus, it takes 3 ms for the client device 2 to receive response B after making request B, and theoretically, time is reduced by 7 ms compared to response time to the capture data.

At a third request of data A, since data A is not data to be cached and time is taken the same as in capturing data, a measured value is the same as a theoretical value. Then, at fourth and fifth requests of data B, data B is data to be cached, time for reading data from the DB server 4 is reduced to be 1 ms of a theoretical value. Therefore, it takes 3 ms for the client device 2 to receive response B after making request B, and theoretically, time is reduced by 7 ms compared to response time to the capture data.

In this manner, the verification execution unit 25 and the like of the verification server 20 can calculate a theoretical value of response time for each cache scenario using respective capture data of requests Nos. 1 to 10. In correlation with data of each request number of each cache scenario, the verification execution unit 25 and the like generate information in which a measured value of response time, a theoretical value of response time, and response time between AP-DB that the DB server 4 indicates time according to a response are correlated with each other.

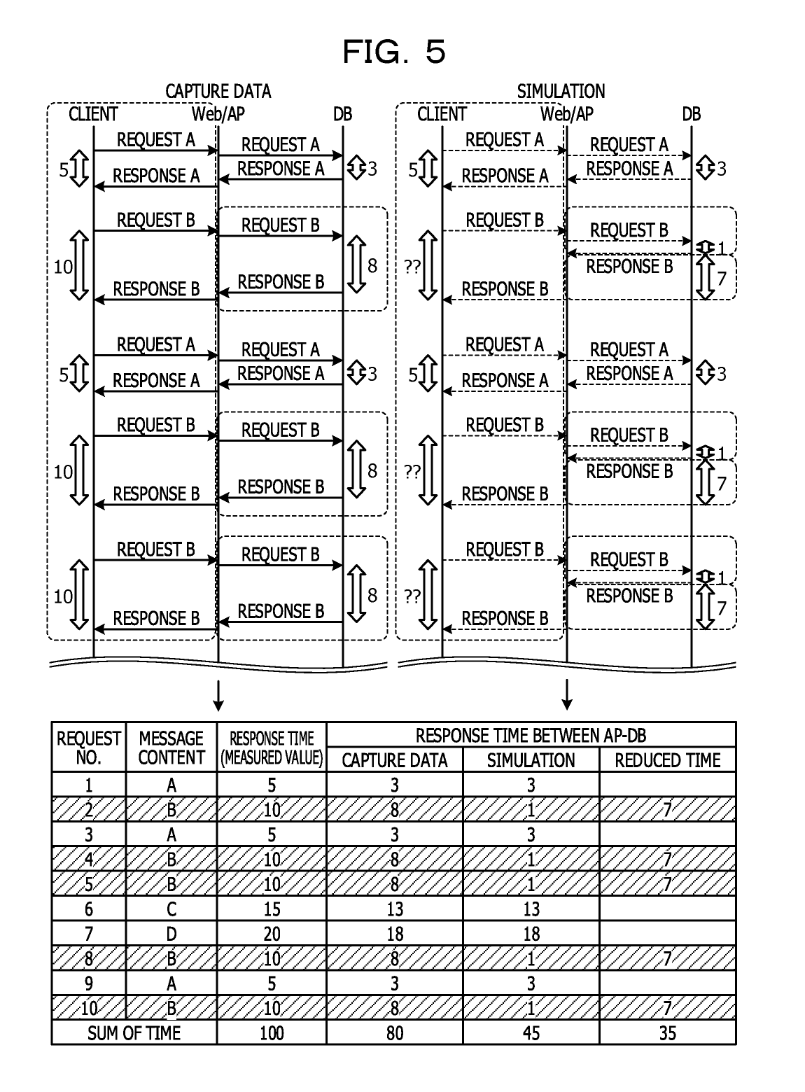

Although there is no interconnection among the client device 2, the Web/AP server 3, and the DB server 4, it is possible to calculate a theoretical value. FIG. 5 is a diagram illustrating a calculation of theoretical values in an environment in which there is no interconnection among devices. The other conditions are set to be the same as in FIG. 4.

In FIG. 5, since there is no interconnection between devices, a measured value and a theoretical value are compared with each other by focusing not on time from a request to a response but time for reading in the DB server 4. Specifically, as illustrated in FIG. 5, at first and third requests of data A, it takes 3 ms to read data from the DB server 4 when capturing data. However, since data A are not data to be cached, the theoretical value becomes the same as the measured value.

At second, fourth, and fifth requests of data B, it takes 8 ms to read data from the DB server 4 using the capture data. On the other hand, since data B is data to be cached, and theoretically is assumed to be read from the cache server in 1 ms, it is anticipated that data reading time is reduced by 7 ms.

In this manner, time for reading captured data and a theoretical value become the same as each other for data which are not to be cached, and data reading time is reduced to be 1 ms for data to be cached. Using this method, it is possible to calculate a theoretical value of response time for each cache scenario.

As a result, in correlation with data of each request number of each cache scenario, the verification execution unit 25 and the like generate information in which a measured value of response time, a theoretical value of response time, and response time between AP-DB in which the DB server 4 indicates time according to a response are correlated with each other. The response time between AP-DB includes capture data which indicates time actually taken in the operating system 1, a simulation which is a theoretical value, and time reduced by the simulation.

Returning to FIG. 2, the control unit 23 is a processing unit which is in charge of processing of the entire verification server 20, and includes a packet processing unit 24, a verification execution unit 25, and a specification unit 26. For example, the control unit 23 is an electronic circuit such as a processor and the like. Each processing unit corresponds to an electronic circuit of a processor, a process performed by the processor, or the like.

The packet processing unit 24 is a processing unit which captures a packet of data requests transmitted or received in the operating system 1, and includes an acquisition unit 24a and a measurement unit 24b.

The acquisition unit 24a is a processing unit which acquires the packet transmitted or received in the operating system, and stores the packet in a capture DB 22a. Specifically, the acquisition unit 24a acquires a packet of HTTP request which is transmitted from the client device 2 to the Web/AP server 3 or a packet of HTTP response which is transmitted from the Web/AP server 3 to the client device 2 from the HTTP capture device 5.

The acquisition unit 24a acquires a packet of SQL statement which is transmitted from the Web/AP server 3 to the DB server 4 or a packet of SQL response which is transmitted from the DB server 4 to the Web/AP server 3 from the SQL capture device 6.

As described above, the acquisition unit 24a acquires a packet of a request for Data A. The acquisition unit 24a stores a packet correlated with a request for respective data. In other words, with regard to requests for Data A, the acquisition unit 24a stores each packet of the HTTP request, the SQL statement, the SQL response, and the HTTP response in correlation with each other.

The measurement unit 24b is a processing unit which measures a measured value of response time to respective data. Specifically, the measurement unit 24b measures time between when a request is transmitted from the client device 2 and when the client device 2 receives a response from the packet stored in the capture DB 22a. The time measured herein is used in creation of a cache scenario, and the like as a measured value of response time to a request for respective data. The measurement unit 24b may packet-capture the operating system 1 and measure response time to a request for respective data.

The verification execution unit 25 includes a scenario selection unit 25a, a client pseudo unit 25b, a DB server pseudo unit 25c, a cache server pseudo unit 25d, and an estimation unit 25e. The verification execution unit 25 is a processing unit which verifies an effect of cache introduction in each cache scenario using these units.

The scenario selection unit 25a is a processing unit which selects a cache scenario to be verified. Specifically, the scenario selection unit 25a selects one cache scenario when verification processing is started. Then, the scenario selection unit 25a notifies the client pseudo unit 25b, the DB server pseudo unit 25c, the cache server pseudo unit 25d, and the estimation unit 25e of the selected cache scenario.

When verification processing on the selected cache scenario is finished, the scenario selection unit 25a selects an unselected cache scenario and executes verification processing thereon. Although a selection order can be arbitrarily set, the scenario selection unit 25a can sequentially select a cache scenario, for example, from a top of the cache scenario number. The scenario selection unit 25a can narrow a cache scenario whose theoretical value is equal to or less than a predetermined value as a cache scenario to be verified. By doing so, verification processing on a cache scenario which is expected to have a small effect after the introduction of the cache server can be omitted, and this leads to shortening of the verification processing.

The client pseudo unit 25b is a processing unit which performs an operation of the client device 2 in a pseudo manner. Specifically, the client pseudo unit 25b executes processing of transmitting the HTTP request which is a start of requests and processing of receiving the HTTP response which is an end of requests in a pseudo manner.

For example, the client pseudo unit 25b executes transmission and response of a data request corresponding to each request number when performing verification of a cache scenario of the cache scenario No. 1 illustrated in FIG. 3.

As an example, in a case of cache scenario No. 1, the client pseudo unit 25b first acquires a packet corresponding to an HTTP request for data A of a request No. 1 from the capture DB 22a and transmits the packet to the verification Web server 30. Then, when receiving an HTTP response of Data A of request No. 1 from the verification Web server 30, the client pseudo unit 25b acquires a packet corresponding to an HTTP request for Data B of request No. 2 from the capture DB 22a, and transmits the packet to the verification Web server 30.

Thereafter, when receiving an HTTP response of Data B of request No. 2 from the verification Web server 30, the client pseudo unit 25b acquires a packet corresponding to an HTTP request for Data A of request No. 3 from the capture DB 22a and transmits the packet to the verification Web server 30. As described above, the client pseudo unit 25b executes an HTTP request, and executes an HTTP request corresponding to a next request number when receiving a response to the request.

A DB server pseudo unit 25c is a processing unit which performs an operation of the DB server 4 in a pseudo manner. Specifically, the DB server pseudo unit 25c receives a SQL statement on data except data to be cached from the verification Web server 30. Then, the DB server pseudo unit 25c executes the received SQL statement, executes reading of data, and transmits a SQL response to the verification Web server 30. This DB server pseudo unit 25c executes the same processing as the DB server 4 of the operating system 1. Then, the DB server pseudo unit 25c takes the same processing time as the DB server 4 to respond to the SQL statement.

Assuming that the cache server is added to the operating system 1, the cache server pseudo unit 25d is a processing unit which performs an operation of the cache server in a pseudo manner. Specifically, the cache server pseudo unit 25d receives a SQL statement on data to be cached from the verification Web server 30. Then, the cache server pseudo unit 25d executes the received SQL statement, executes reading of data, and the like, and transmits a SQL response to the data to the verification Web server 30.

Here, assuming time for reading data from the cache server as 1 ms, the cache server pseudo unit 25d responds to SQL statements. That is, the cache server pseudo unit 25d sets time between a reception of the SQL statements and a response to the SQL statements to be 1 ms, and executes data reading from a cache.

Here, a theoretical value is assumed to be 1 ms as an example; however, the theoretical value is not limited thereto. For example, the cache server pseudo unit 25d can calculate a processing load from the number of request processing and the like of the operating system 1, and respond in response time according to the processing load. As an example, the cache server pseudo unit 25d can assume reading data from the cache server to be 1.6 ms to be processed when the processing load at a time zone to execute verification is higher than a predetermined value.

The estimation unit 25e is a processing unit which estimates response time to a request for data to be cached when the cache server is introduced, using accumulated packets in each cache scenario in which data to be cached is defined. Specifically, the estimation unit 25e monitors processing executed by each of the client pseudo unit 25b, the DB server pseudo unit 25c, and a cache server pseudo unit 25d, and generates a verification result.

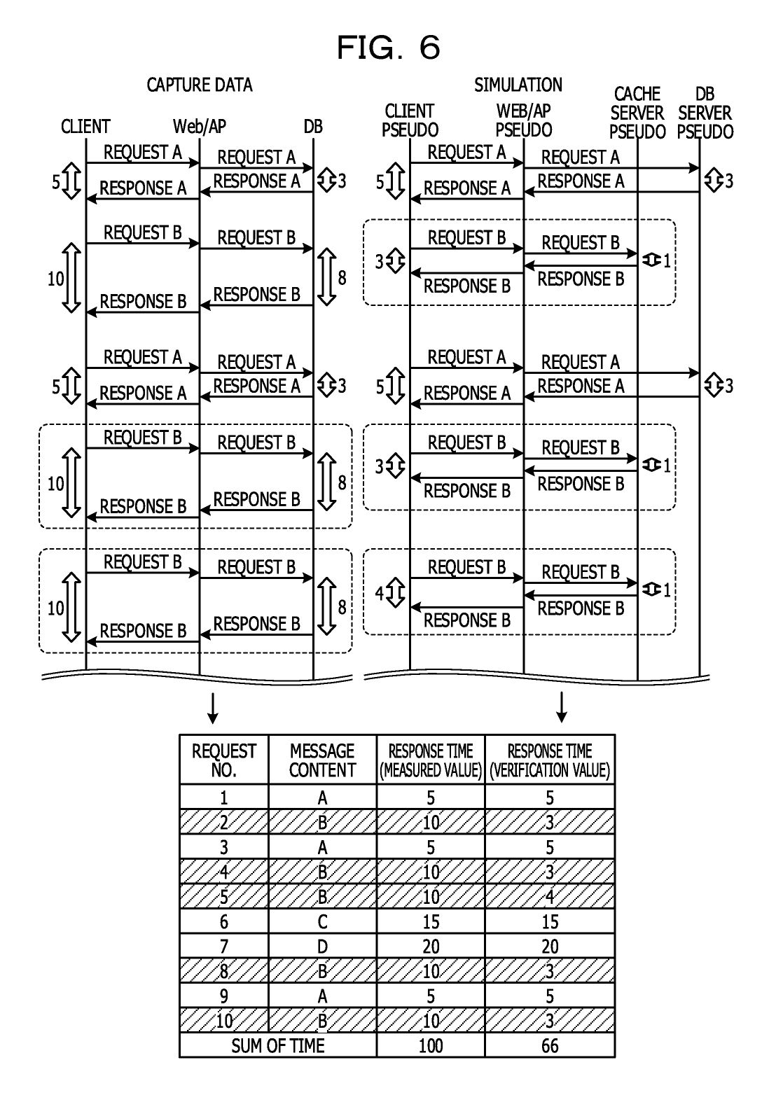

Here, an example in which the estimation unit 25e estimates a verification value in each cache scenario will be described. FIG. 6 is a diagram illustrating calculation of verification values. An example illustrated in FIG. 6 will be described as an example the same as FIG. 4. As illustrated in FIG. 6, at an initial request for data A, since data A is not cached, the DB server pseudo unit 25c responds to data A at time intervals the same as in capturing data. Therefore, the estimation unit 25e estimates that a measured value and a verification value are the same as each other with regard to initial data A.

At a next request for data B, since data B is cached, the cache server pseudo unit 25d responds to data B in 1 ms of a theoretical value. Therefore, the estimation unit 25e estimates time between a request for second data B and a response to the request to be 3 ms, and estimates time is reduced by 7 ms compared to a measured value.

At a next request for data A, since data A are not cached, the DB server pseudo unit 25c responds to data A at time intervals the same as in capturing data. Accordingly, the estimation unit 25e estimates that a measured value and a verification value of initial data A are the same as each other.

At a next request for data B, since data B is cached, the cache server pseudo unit 25d responds to data B in 1 ms of a theoretical value. Accordingly, the estimation unit 25e estimates time between a request for second data B and a response to the request to be 3 ms, and estimates time is reduced by 7 ms compared to a measured value.

Furthermore, likewise at a next request for data B, since data B are cached, the estimation unit 25e estimates time between a request for second data B and a response to the request to be 4 ms, and estimates time is reduced by 6 ms compared to a measured value.

In this manner, the estimation unit 25e estimates response time when the cache server is introduced into the operating system 1 from response time of each packet processed by each pseudo unit in a pseudo manner in each cache scenario. The estimation unit 25e correlates an estimated value estimated in each cache scenario with a measured value and the like of the cache scenario and stores them in the storage unit 22.

Based on response time in each cache scenario estimated by the estimation unit 25e, the specification unit 26 is a processing unit which specifies a cache scenario satisfying system requirements when the cache server is introduced. Specifically, the specification unit 26 presents a cache scenario satisfying Service Level Agreement (SLA) of a user to a user according to an estimation result stored in the storage unit 22 by the estimation unit 25e.

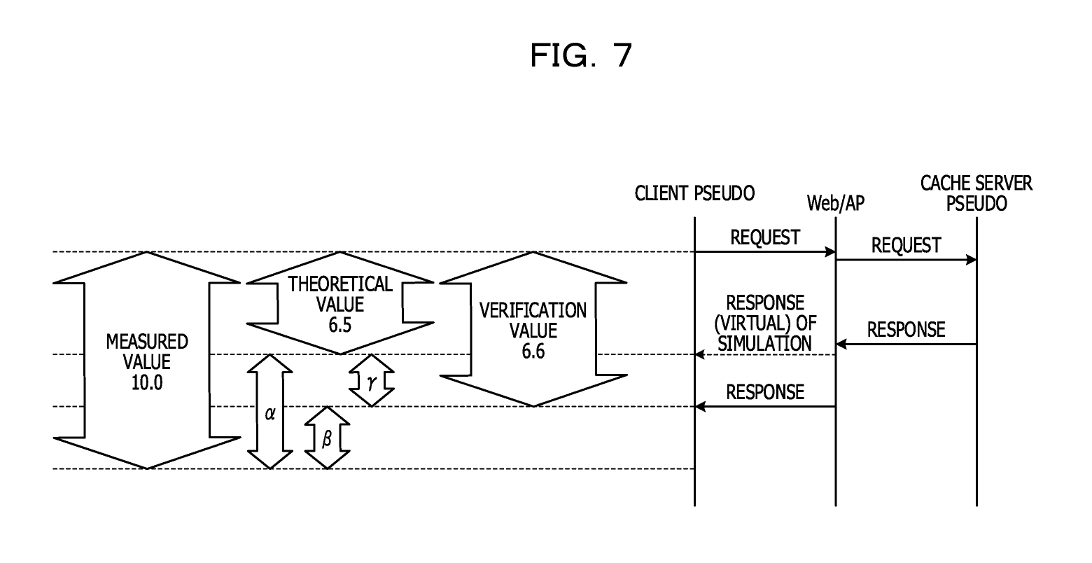

FIG. 7 is a diagram illustrating a cache effect. “α” illustrated in FIG. 7 is a maximum cache effect index. The maximum cache effect index is a difference between a measured value and a theoretical value of response time. The maximum cache effect index is a degree of improvement when a cache effect is maximized assuming there is no bottleneck of the Web/AP server 3. For example, the specification unit 26 calculates the maximum cache effect index by (measured value (A)-theoretical value (B))/measured value (A).

“β” illustrated in FIG. 7 is a real cache effect index. The real cache effect index is a difference between a theoretical value and a verification value of response time. The real cache effect index is in a state that the bottleneck of the Web/AP server 3 in the verification system 10 is reflected in the response time, and is a degree of an actual cache effect. For example, the specification unit 26 calculates the real cache effect index by (measured value (A)-verification value (C)/measured value (A)).

“γ” illustrated in FIG. 7 is a limited cache effect index. The limited cache effect index is a difference between the verification value and the measured value of the response time. The limited cache effect index is a degree of cache effect appearing when the bottleneck of the Web/AP server is solved. For example, the specification unit 26 calculates a limited cache effect index by (verification value (C)-theoretical value (B)/verification value (C)).

That is, as the theoretical value and the verification value get close to each other, an operation becomes close to a simulation and a load of the Web/AP server 3 becomes small. That is, as the limited cache effect index (γ) gets close to 0, it can be anticipated that a cache effect expected in a configuration of the current operating system 1 occurs

On the other hand, as the theoretical value and the verification value are apart from each other, an operation becomes different from a simulation, and the load of the Web/AP server 3 becomes large. That is, as the limited cache effect index (γ) gets close to one, a load of the Web/AP server 3 is high in the configuration of the current operating system 1. Therefore, it can be anticipated that the cache effect comes out by performing a scale up or a scale out of the Web/AP server 3.

As described above, the specification unit 26 calculates the maximum cache effect index (α), a real cache effect index (β), and a limited cache effect index (γ) using a verification result of each cache scenario obtained by each processing unit of the verification execution unit 25. Then, the specification unit 26 presents a cache scenario satisfying SLA to a user.

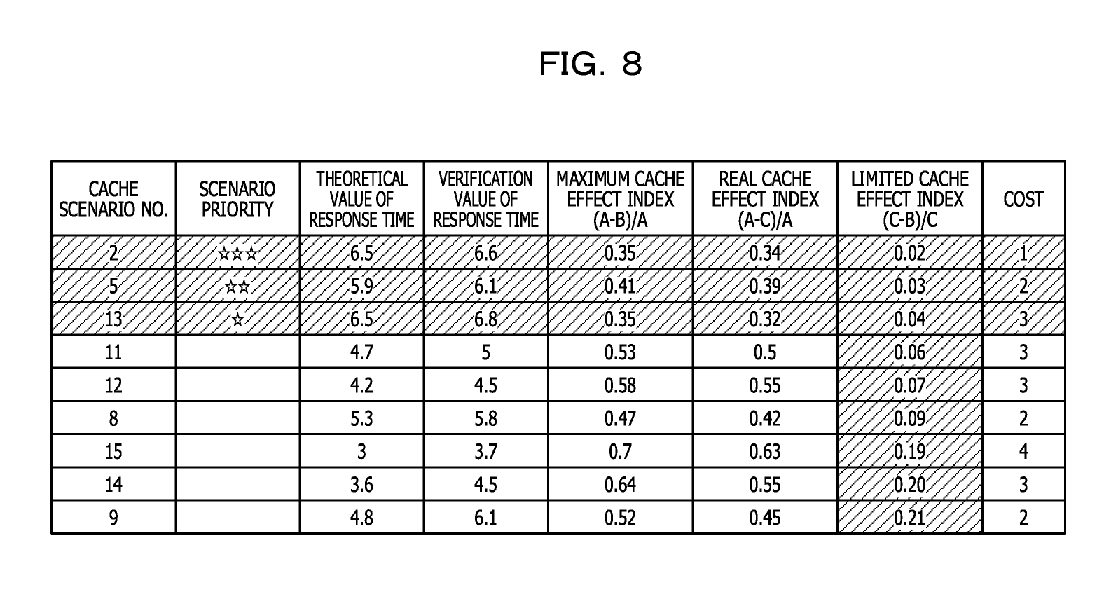

Next, the specification unit 26 describes a presented example of a cache scenario which satisfies SLA using FIGS. 8 to 11. A cache scenario number of FIGS. 8 to 11 is set to be the same as in FIG. 3. FIG. 8 is a diagram illustrating an example of scenario selection in which a cache effect is maximized. As illustrated in FIG. 8, the specification unit 26 calculates each effect index, and then switches limited cache effect indexes (γ) in an ascending order. Then, the specification unit 26 specifies top three cache scenarios Nos. 2, 5, and 13 in which the limited cache effect indexes (γ) are small.

As a result, the specification unit 26 displays a cache scenario No. 2 on a display and the like, and displays a message of “when data B is cached, effects caused by introduction of the cache server can be expected to be maximized, and the like. The specification unit 26 can also display a message saying that large effects can be expected in a cache scenario No. 5 in which data A or B are cached, and a cache scenario No. 13 in which any of data A, C, and D is cached.

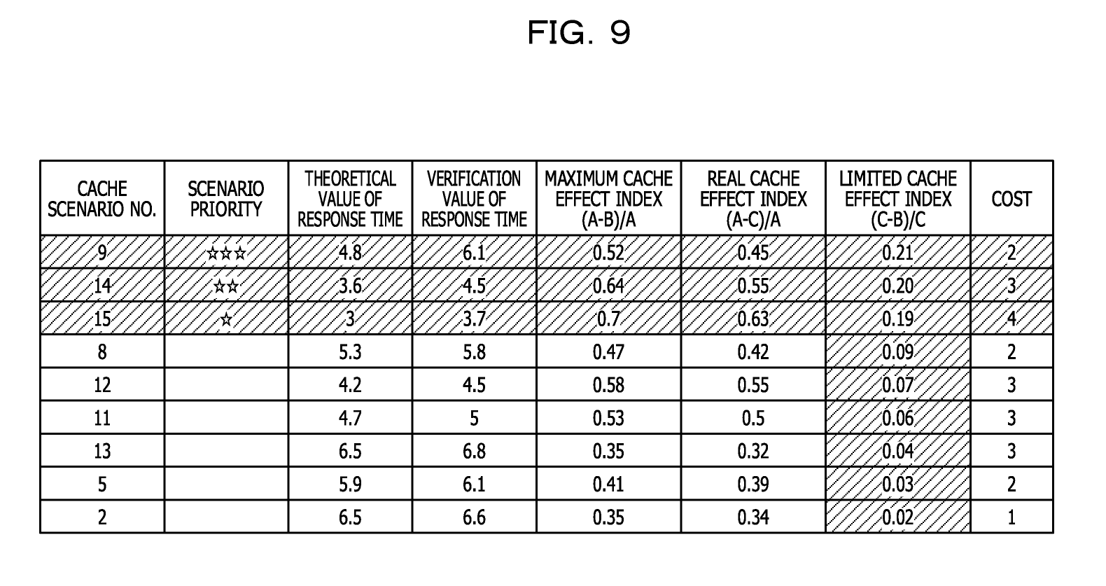

FIG. 9 is a diagram illustrating an example of selecting a scenario in which a cache effect is large when AP is improved. AS illustrated in FIG. 9, the specification unit 26 calculates each effect index, and then switches limited cache effect indexes (γ) in a descending order. Then, the specification unit 26 specifies top three cache scenarios Nos. 9, 14, and 15 which have a large limited cache effect index (γ).

As a result, the specification unit 26 displays a cache scenario No. 9 on a display and the like, and displays a message of “data B or D are cached” and the like. The specification unit 26 can display a message saying effects by AP improvement can be expected even in a cache scenario No. 14 in which any of data B, C, and D is cached. In a similar manner, the specification unit 26 can display a message saying effects by AP improvement can be expected even in a cache scenario No. 15 in which any of data A, B, C, and D is cached.

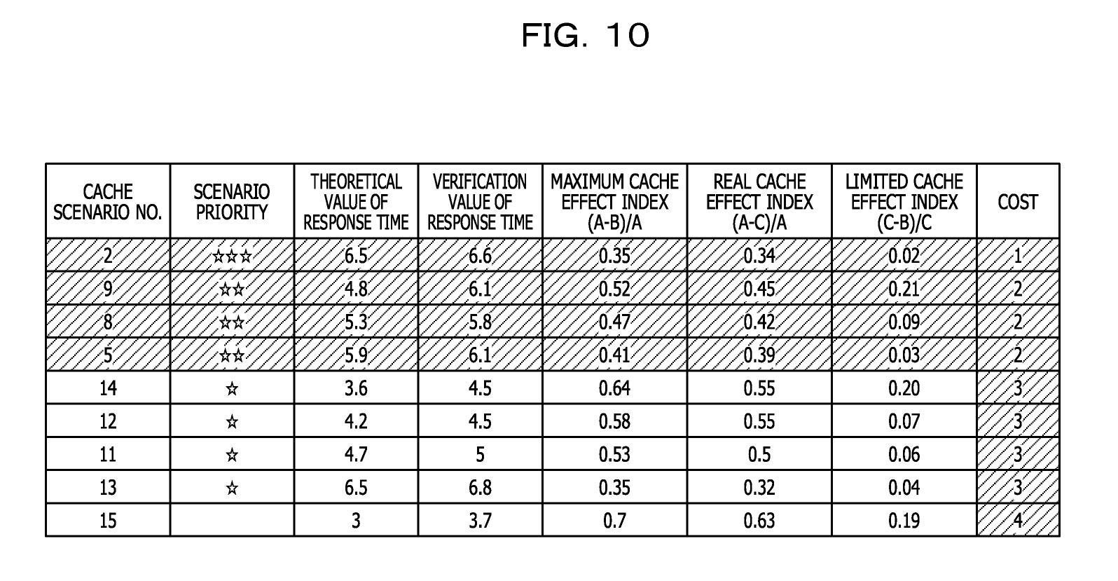

FIG. 10 is a diagram illustrating an example of selecting a scenario in which cost is suppressed. Here, cost is a sum of capacity of a cache memory and the like used to cache data or expense consumed in AP improvement. An administrator and the like can calculate cost in each cache scenario in advance to be set. In FIG. 10, as a value of cost is large, this indicates cost is large. As illustrated in FIG. 10, the specification unit 26 calculates each effect index, and then switches costs in an ascending order. Then, the specification unit 26 specifies top three cache scenarios Nos. 2, 9, 8 and 5 in which costs are small.

As a result, the specification unit 26 displays a cache scenario No. 2 on a display and the like, and also displays a message of “when data B is cached, a cache effect can be expected while suppressing costs” and the like. The specification unit 26 can display a message saying “a cache effect can be expected while suppressing costs in a cache scenario No. 9 in which data B or D are cached. In a similar manner, the specification unit 26 can display a message saying “a cache effect can be expected while suppressing costs in a cache scenario No. 8 or 5.

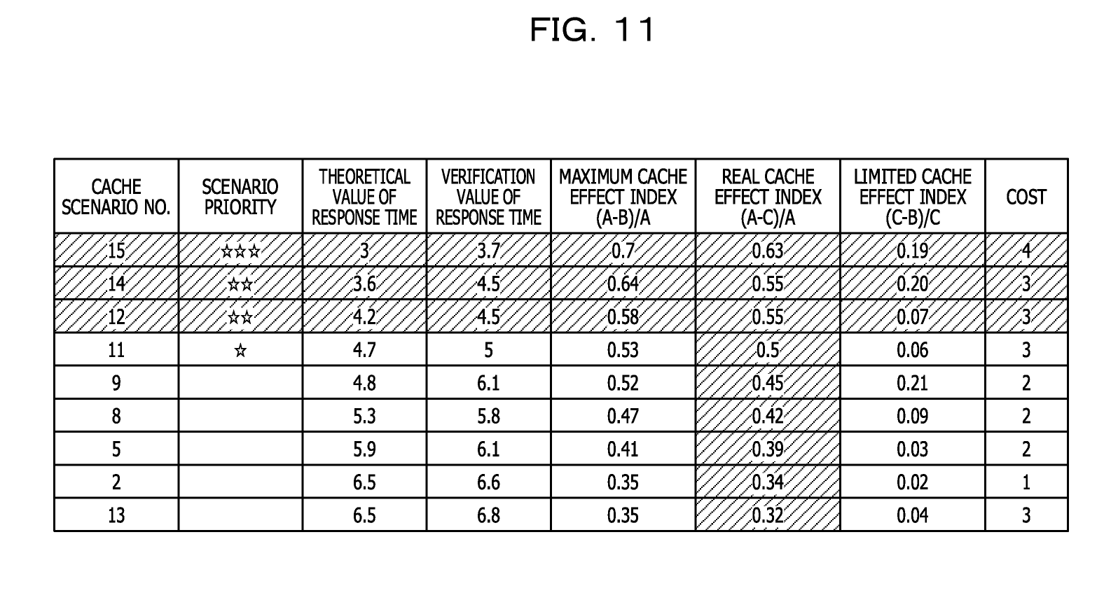

FIG. 11 is a diagram illustrating an example of selecting an optimum scenario in which cost is ignored. As illustrated in FIG. 11, the specification unit 26 calculates each effect index, and then switches real cache effect indexes (β) in a descending order. Then, the specification unit 26 specifies top three of cache scenarios Nos. 15, 14, and 12 in which the real cache effect index (β) is large.

As a result, the specification unit 26 displays a cache scenario No. 15 on a display and the like, and also displays messages such as “if data are any one of A, B, C, and D, cost for caching the data is large, but a maximum cache effect can be expected” and the like. The specification unit 26 can display a message saying a cache effect can be expected regardless of costs in the same manner in cache scenario No. 14 in which any of data B, C, and D is cached. Likewise, the specification unit 26 can display a message saying a cache effect can be expected regardless of costs in the same manner even in cache scenario No. 12 in which any of data A, B, and D is cached.

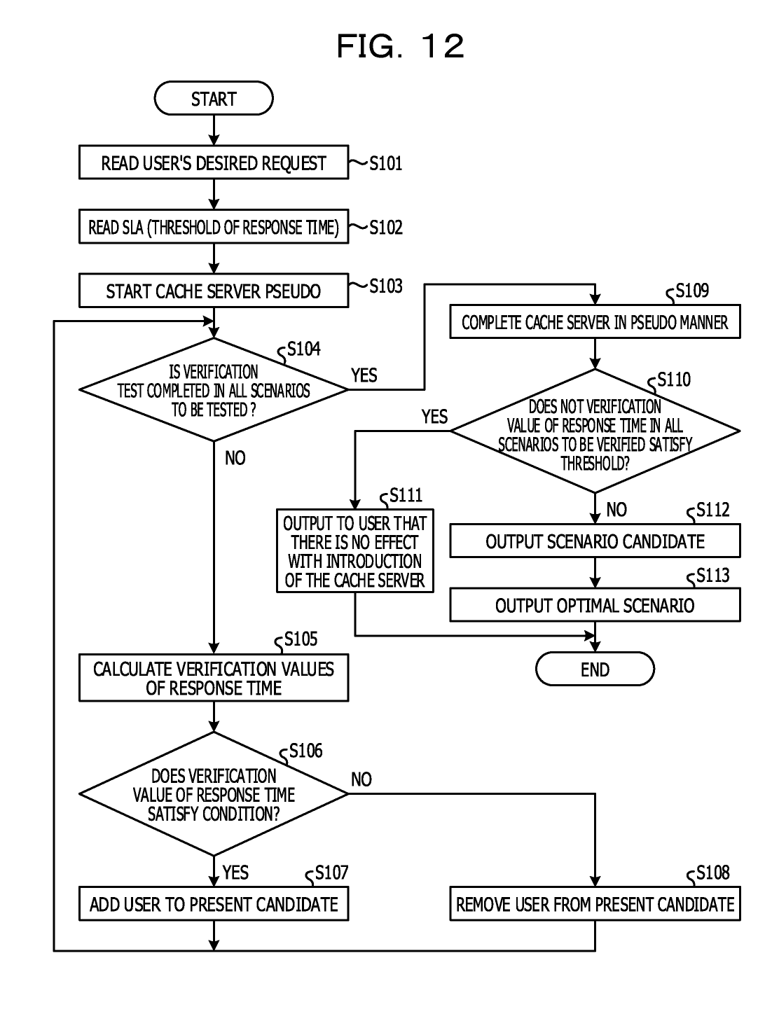

FIG. 12 is a flowchart illustrating a flow of verification processing according to Embodiment 1. As illustrated in FIG. 12, the specification unit 26 of the verification server 20 reads a user's desired request from the storage unit 22 and the like when verification processing is disclosed (S101). The scenario selection unit 25a of the verification execution unit 25 reads a threshold of response time which is set by an administrator and is stored in the storage unit 22 and the like (S102).

Thereafter, the verification execution unit 25 selects one cache scenario. Then, the verification execution unit 25 starts a cache server using the cache server pseudo unit 25d in a pseudo manner (S103), and executes verification processing on a cache scenario.

Then, when a scenario in which verification processing is not completed is left (S104: No), the estimation unit 25e calculates verification values of response time in a scenario in which verification processing is completed (S105).

Continuously, the specification unit 26 adds a user to a present candidate (S107) when a verification value of response time in the scenario satisfies a request of S101 (S106: Yes). On the other hand, the specification unit 26 excludes a user from a present candidate (S108) when a verification value of response time in the scenario does not satisfy a request of S101 (S106: No).

On the other hand, in S104, when it is determined that a scenario in which verification processing is not completed is not left (S104: Yes), the cache server pseudo unit 25d completes a cache server in a pseudo manner (S109).

Afterwards, the specification unit 26 presents to a user that there is no effect with an introduction of the cache server (S111) when a verification value of response time in all scenarios to be verified does not satisfy a threshold of S102 (S110: Yes).

On the other hand, the specification unit 26 outputs a scenario which is a present candidate in the storage unit 22, a display, or the like (S112) when a verification value of response time in any scenario to be verified satisfies a threshold of S102 (S110: No). Furthermore, the specification unit 26 outputs an optimal scenario which meets user's condition received in S101 to the storage unit 22, the display, or the like (S113).

In this manner, the verification server 20 can detect optimal data to be cached from assumed data to be cached within a short period of time. The verification server 20 can present a user with a selection of cache scenario which meets a user's condition. Therefore, it is possible to reduce time for user's determination on introduction of a cache server.

The verification server 20 can find an optimal cache scenario or a candidate using a theoretical value, a measured value, and a test result. Therefore, it is possible to reduce time for introduction of a cache. With the verification server 20, an effect of time reduction is anticipated by narrowing a scenario using a theoretical value of a cache. The verification server 20 is used as a cache server in a pseudo manner, and thereby it is possible to reduce labor of the cache server in setting up.

### Embodiment 2

Incidentally, the verification server 20 can automatically generate a cache scenario using a packet capture of the operating system 1. In Embodiment 2, an example in which the verification server 20 generates a cache scenario will be described.

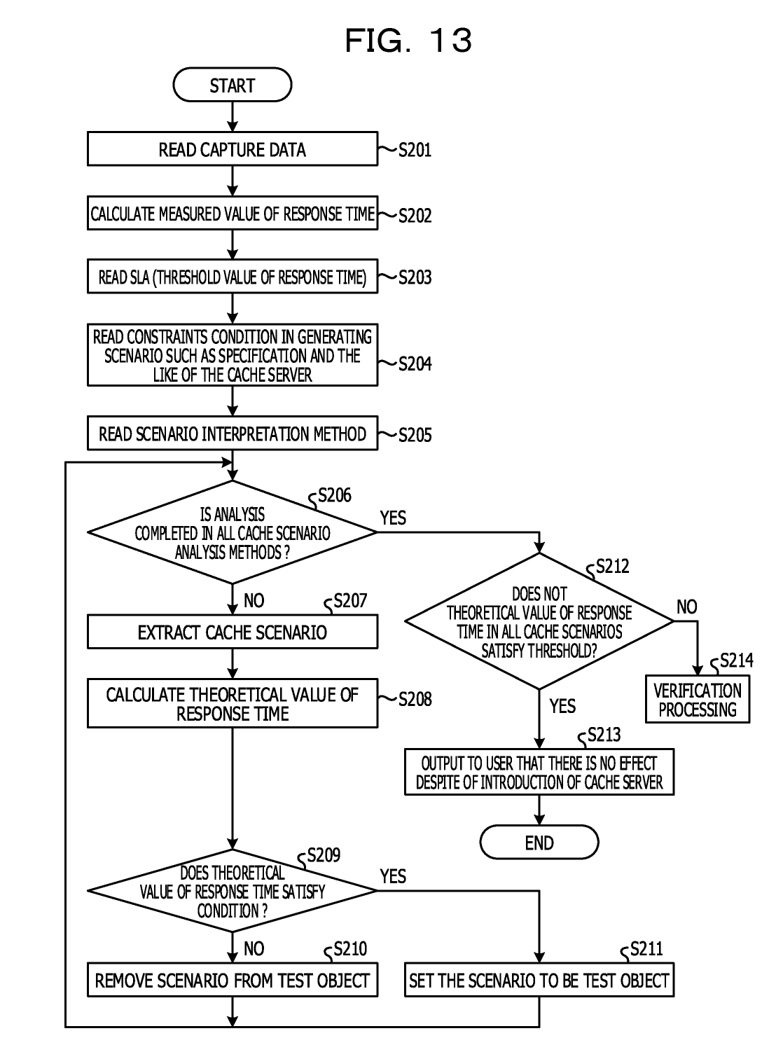

FIG. 13 is a flowchart illustrating a flow of scenario generation processing according to Embodiment 2. As illustrated in FIG. 13, the verification execution unit 25 reads capture data from the capture DB 22a when processing is started (S201). Subsequently, the verification execution unit 25 calculates a measured value of response time in a request for respective data (S202).

Then, the verification execution unit 25 reads a threshold value of response time set by an administrator (S203). Subsequently, the verification execution unit 25 reads constraints condition in generating a scenario such as specification and the like of the cache server (S204). Subsequently, the verification execution unit 25 reads a scenario interpretation method (S205). The constraints condition and the scenario interpretation method are made by an administrator according to a request from a user.

Thereafter, the verification execution unit 25 extracts a cache scenario in which processing is not completed (S207) when a method in which processing is not completed is left among cache scenario interpretation methods (S206: No). Subsequently, the verification execution unit 25 calculates a theoretical value of response (S208).

Then, the verification execution unit 25 excludes the scenario from test objects (S210) when a theoretical value of response time of the cache scenario does not satisfy a condition specified in advance (S209: No).

On the other hand, the verification execution unit 25 sets the scenario to be a test object (S211) when a theoretical value of response time of the cache scenario satisfies a condition set specified in advance (S209: Yes).

Then, the verification execution unit 25 executes S212 when processing is completed in all cache scenario analysis methods (S206: Yes). That is, the verification execution unit 25 presents to a user that there is no effect despite of introduction of a cache server (S213) when a theoretical value of response time in all scenarios to be verified does not satisfy a threshold of S203 (S212: Yes). On the other hand, the verification execution unit 25 executes verification processing of FIG. 12 (S214) when a theoretical value of response time in any scenario to be verified satisfies a threshold of S203 (S212: No).

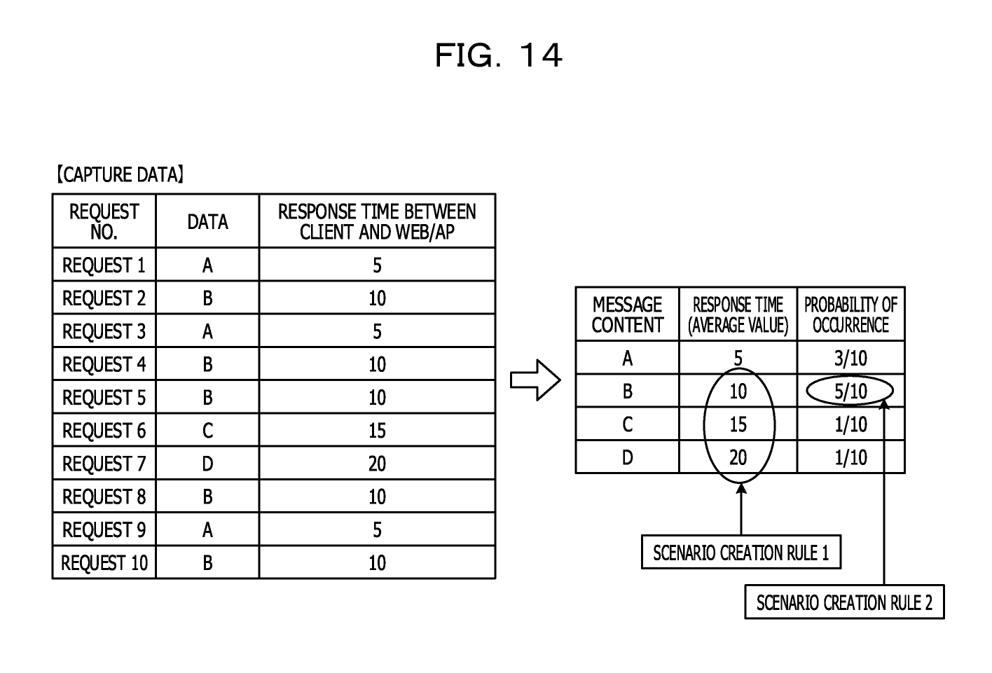

Then, a detailed example of scenario generation will be described using FIGS. 14 to 16. FIG. 14 is a diagram illustrating detailed example 1 of scenario generation according to Embodiment 2. Capture data illustrated in a left diagram of FIG. 14 is a packet capture of requests Nos. 1 to 10. The packet capture is data in which data and response time between a request for the data and reception of a response by the client device 2 are correlated with each other.

Specifically, response time of first data A is 5 ms. Response time of second data B is 10 ms. Response time of third data A is 5 ms. Response time of fourth data B is 10 ms. Response time of fifth data B is 10 ms. Response time of sixth data C is 15 ms. Response time of seventh data D is 20 ms. Response time of eighth data B is 10 ms. Response time of ninth data A is 5 ms. Response time of tenth data B is 10 ms.

Then, the verification execution unit 25 calculates response time and probability of occurrence for respective data according to capture data. Specifically, as illustrated in a right diagram of FIG. 14, the verification execution unit 25 calculates an average of response time as five from three captured data A in capturing data and a sum of response time which is 15 ms, and sets the probability of occurrence to be 3/10. The verification execution unit 25 calculates an average of response time as ten from five captured data B in capturing data and a sum of response time which is 50 ms, and sets the probability of occurrence to be 5/10.

The verification execution unit 25 calculates an average of response time as fifteen from one captured data C in capturing data and a sum of response time which is 15 ms, and sets the probability of occurrence to be 1/10. The verification execution unit 25 calculates an average of response time as twenty from one captured data D in capturing data and a sum of response time which is 20 ms, and sets the probability of occurrence to be 1/10.

From the results, for example, the verification execution unit 25 generates a cache scenario in which data B, C, and D are cached when top three whose response time is long are set to be a scenario creation rule 1. As an example, the verification execution unit 25 generates a cache scenario in which data B, data C, data D, data B and C, data B and D, data C and D, data B and C and D are respectively set to be cached.

As another example, the verification execution unit 25 generates a cache scenario in which data B is to be cached when setting the probability of occurrence of 25% or more to be a scenario creation rule 2. In such a manner, the verification execution unit 25 arbitrarily combines an average value of response time measured in capturing data and the probability of occurrence to generate a cache scenario.

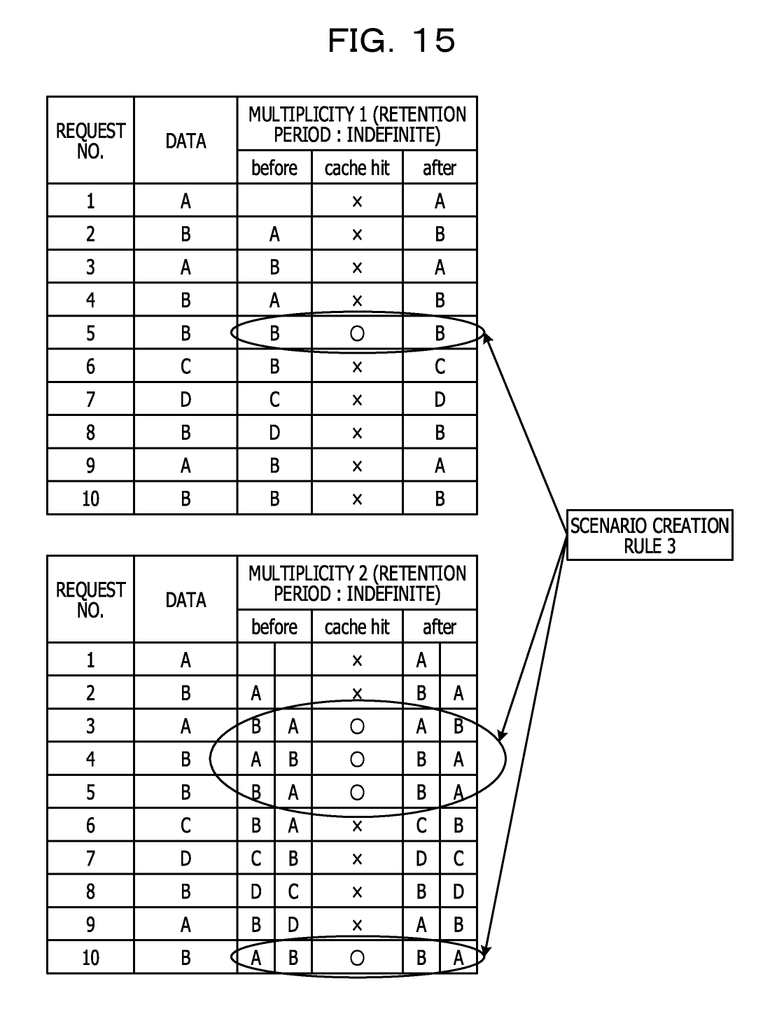

FIG. 15 is a table illustrating detailed example 2 of scenario generation according to Example 2. The capture data table illustrated at an upper left diagram of FIG. 15 includes packet captures of requests Nos. 1 to 10. FIG. 15 is a table illustrating presence or absence of a cache hit when caching one piece of data (multiplicity 1).

Specifically, the verification execution unit 25 caches data in an order of data to be captured. Then, the verification execution unit 25 determines whether respective data is a cache hit or a cache miss to generate a result of the determination. At an upper left table of FIG. 15, “multiplicity, retention period, (before, cache hit, after)” are correlated with data for each request number.

“Multiplicity” is the number of data to be cached. One is in an example at an upper left table of FIG. 15. “Retention period” is a period which retains cache data, and is indefinite at the upper left table of FIG. 15. “Before” indicates data to be already cached when data are received. “Cache hit” indicates whether or not the received data performs a cache hit. “After” indicates data which are cached after determining whether or not the received data perform a cache hit, and are received data herein.

For example, since any of data is not cached, the verification execution unit 25 caches initial data A as they are. Then, since data A is cached, the verification execution unit 25 determines next data B is a cache miss and caches data B.

Continuously, since data B is cached, the verification execution unit 25 determines next data A is a cache miss, and caches data A. Moreover, since data A is cached, the verification execution unit 25 determines next data B is a cache miss, and caches data B. Then, since data B is already cached, the verification execution unit 25 determines next data B is a cache hit and data B is assumed to be removed from a cache.

In this manner, the verification execution unit 25 caches data in an order of data to be captured, determines whether respective data is a cache hit or cache miss, and generates a result illustrated in an upper left table of FIG. 15.

A lower left table of FIG. 15 is a table which illustrates an example when multiplicity is two. That is, when the number of data which can be cached is two. For example, with regard to data A at a beginning, since any of the data is not cached, the verification execution unit 25 cached the data as it is. Then, since data A is cached, the verification execution unit 25 determines that the next data B is a cache miss, and caches data B.

Next, since data A and B are cached, the verification execution unit 25 determines that next data A is a cache hit, assumes a removal of data A from a cache, and caches data A. Furthermore, since data A and B are cached, the verification execution unit 25 determines that next data B is a cache hit, assumes a removal of data B from a cache, and caches data B.

Furthermore, since data A and B are cached, the verification execution unit 25 determines that next data B is a cache hit, assumes a removal of data B from the cache, and caches data B. Moreover, since data A and B are cached, the verification execution unit 25 determines that next data C is a cache miss, and caches data C instead of data A cached ahead.

In this manner, the verification execution unit 25 caches captured data using 2 multiplex. Then, the verification execution unit 25 determines whether each data is a cache hit or a cache miss, and generates a result illustrated in lower left diagram of FIG. 15.

The verification execution unit 25 generates a cache scenario by setting the cached data to a scenario creation rule 3 from a cache situation at a left of FIG. 15 generated in a technique described above. Specifically, the verification execution unit 25 generates a cache scenario in which data B is cached, and a cache scenario in which data A or B are cached.

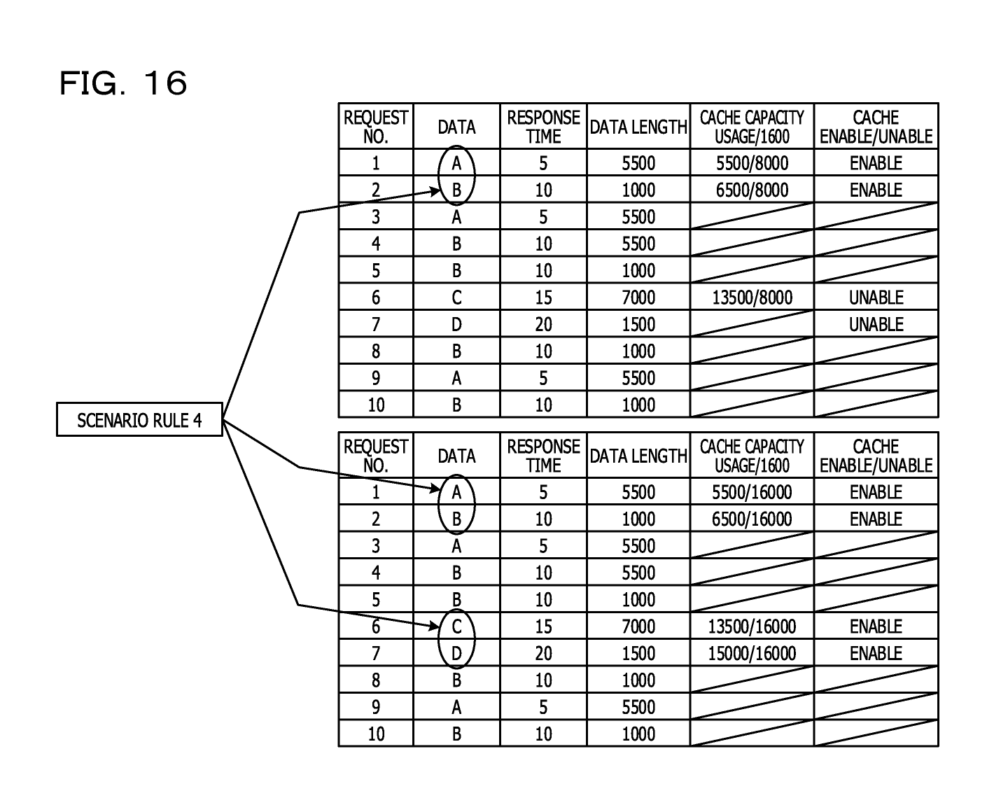

FIG. 16 is a diagram illustrating a detailed example 3 of a scenario generation according to Embodiment 2. The capture data table illustrated in an upper right diagram of FIG. 16 includes packet captures of requests Nos. 1 to 10, and FIG. 16 is a diagram illustrating an example in which a cache capacity is 8000 bites.

Specifically, the verification execution unit 25 assumes a case where data are cached until exceeding a cache capacity in a captured data order, and generates the result. An upper right diagram of FIG. 16 correlates data length, cache capacity (usage/8000), cache enable/unable” with a request number, each data, and response time.

“Data length” displays a capacity of data, and can be specified from a packet and the like of data request. “Cache capacity (usage/8000)” illustrates how much capacity is cached. In “cache enable/cache unable”, a cache enable is set when the cache capacity is not full, and a cache unable is set when the cache capacity is full.

For example, since any data is not cached, the verification execution unit 25 determines that initial data A is cached, and set a data capacity “5500” to be a usage. Here, the verification execution unit 25 sets a cache enable since the cache capacity is not full.

Then, since data A is cached, but data length is “1000” and does not reach an upper limit “8000” of a cache capacity, the verification execution unit 25 determines next data B is to be cached. Then, the verification execution unit 25 sets a data capacity “5500+1000” to be a usage. Here, the verification execution unit 25 sets a cache enable since the cache capacity is not full.

Since data A and data B thereafter are already cached, data A and data B are excluded from a determination of whether or not they are cache enable. Then, since a data length of data C is “7000” and exceeds an upper limit when data C is cached, the verification execution unit 25 determines that data C may not be cached. In a similar manner, since a data length of data D is “1500” and exceeds an upper limit when data D is cached, the verification execution unit 25 determines that data D may not be cached.

As a result, the verification execution unit 25 sets caching data A or B to be a scenario creation rule 4 and generates a cache scenario.

Capture data illustrated in a lower right diagram of FIG. 16 are packet captures from requests Nos. 1 to 10. FIG. 16 is a diagram illustrating an example in which a cache capacity is 16000 bites. In this case, in the same technique as the technique described above, the verification execution unit 25 determines whether received data can be cached or not based on a data length of the received data and a free space of a cache.

As a result, the verification execution unit 25 determines data A, B, C, and D can be cached. Accordingly, the verification execution unit 25 generates a cache scenario in which a case of caching each of data A, B, C, and D and a case of caching a combination of these data are defined as a scenario creation rule 4.

In this manner, the verification server 20 can extract data to be cached from a packet capture, and automatically generate a cache scenario satisfying a cache condition. Therefore, since the verification server 20 can generate a cache situation assumed from the packet capture to perform verification, an administrator can reduce time to generate a cache scenario according to a complex condition.

Since a work load of an administrator can be reduced, verification processing is likely to be executed, and thereby it is easy to determine whether or not to introduce the cache server for an existing system. Therefore, it is possible to introduce a cache server of a cache scenario appropriate to the existing system, and a throughput of the existing system is improved.

### Embodiment 3

Incidentally, each server of the operating system 1 or each server of a verification system 10 can be realized to be a physical server, and can be also realized to be a virtual machine. In Example 3, an example of an embodiment of each server will be described.

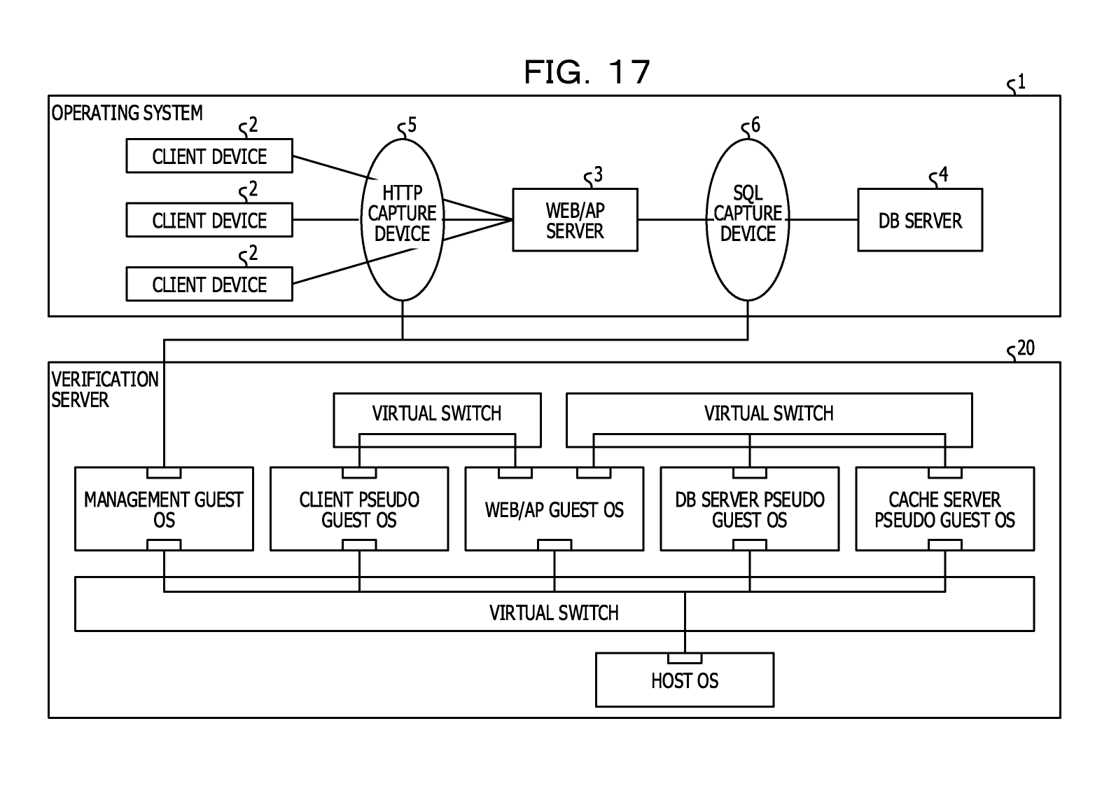

FIG. 17 is a diagram illustrating a system configuration example when the operating system has a physical server and the verification system is a virtual machine. As illustrated in FIG. 17, a device configuration of the operating system 1 is the same as illustrated in FIG. 1, and each device is realized to be a physical device such as a physical server and the like.

On the other hand, the verification server 20 of the verification system 10 is a server device which executes a virtual machine using virtualization software such as hypervisor and the like. Specifically, the verification server 20 operates the virtualization software on a host OS to operate a management guest OS, a client pseudo guest OS, a Web/AP guest OS, a DB server pseudo guest OS, and a cache server pseudo guest OS as a virtual machine. The verification server 20 couples between respective guest OSes using a virtual switch.

The management guest OS is a virtual machine which executes processing the same as the packet processing unit 24 described in FIG. 2 does, and captures a packet through the HTTP capture device 5 and the SQL capture device 6. The management guest OS executes the same processing as each of the scenario selection unit 25a, the estimation unit 25e, and the specification unit 26 described in FIG. 2.

A client pseudo guest OS executes the same processing as the client pseudo unit 25b described in FIG. 2. The Web/AP guest OS executes the same processing as the verification Web server 30 described in FIG. 1. A DB server pseudo guest OS executes the same processing as the DB server pseudo unit 25c described in FIG. 2. A cache server pseudo guest OS executes the same processing as the cache server pseudo unit 25d described in FIG. 2.

In this manner, by realizing the verification system 10 to be the virtual machine, setting changes of hardware resources such as a memory capacity and the like become easy. Since the number of physical servers for verification can be decreased from virtualized environments, it is possible to suppress cost for verification.

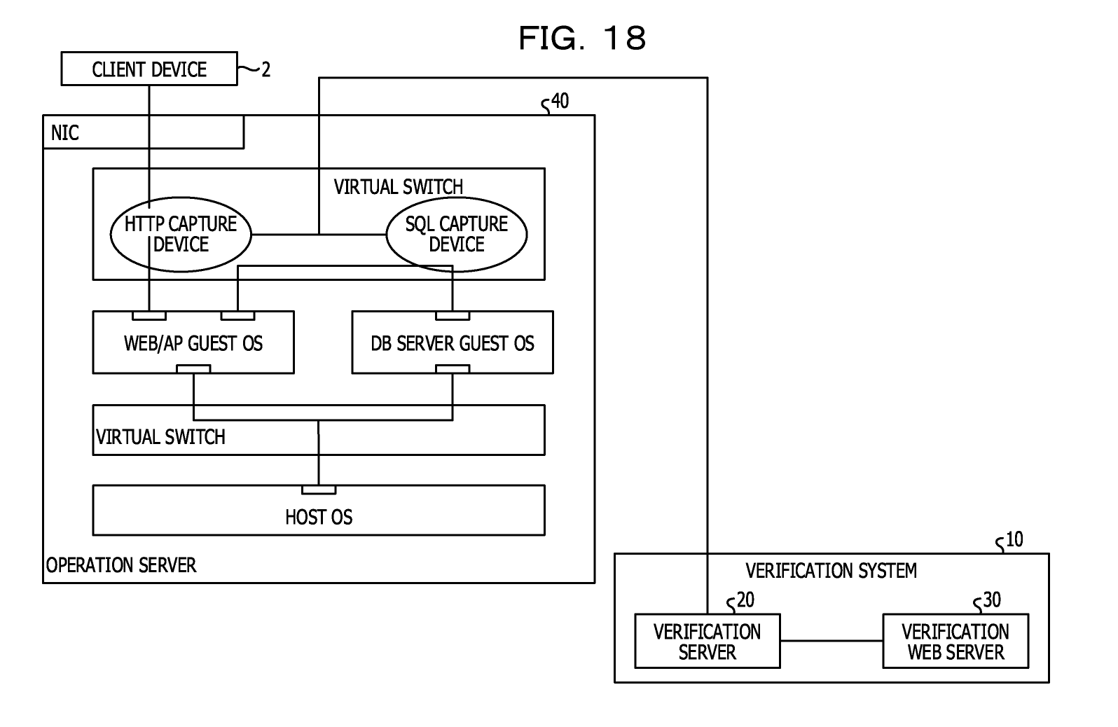

FIG. 18 is a diagram illustrating a system configuration example when the operating system is on the virtual machine and the verification system is on the physical server. As illustrated in FIG. 18, the operation server 40 is a server device which executes the virtual machine using the virtual software such as hypervisor and the like.

Specifically, the operation server 40 operates virtual software on a host OS, and operates a Web/AP guest OS and a DB server guest OS as a virtual machine. The operation server 40 couples each guest OS and a host using a virtual switch. The operation server 40 couples the client device 2 and the Web/AP guest OS through a network interface card (NIC) and the virtual switch.

The operation server 40 is a virtual switch which couples between respective guest OSes. The operation server 40 executes the HTTP capture and the SQL capture. The verification server 20 is coupled to the virtual switch of the operation server 40 and executes packet capturing.

The Web/AP guest OS of the operation server 40 executes the same function as the Web/AP server 3 described in FIG. 1. The DB server guest OS executes the same function as the DB server 4 described in FIG. 1.

In this manner, the operating system 1 is realized in a virtual machine, and thereby time synchronization between the HTTP capture and the SQL capture becomes easy, and collection of the capture data becomes easy. Accordingly, time for creating a cache scenario is reduced. Since time synchronization between respective captures becomes easy, precision or accuracy of the packet capture is improved. Thus, accuracy of a cache scenario or accuracy of verification processing is improved.

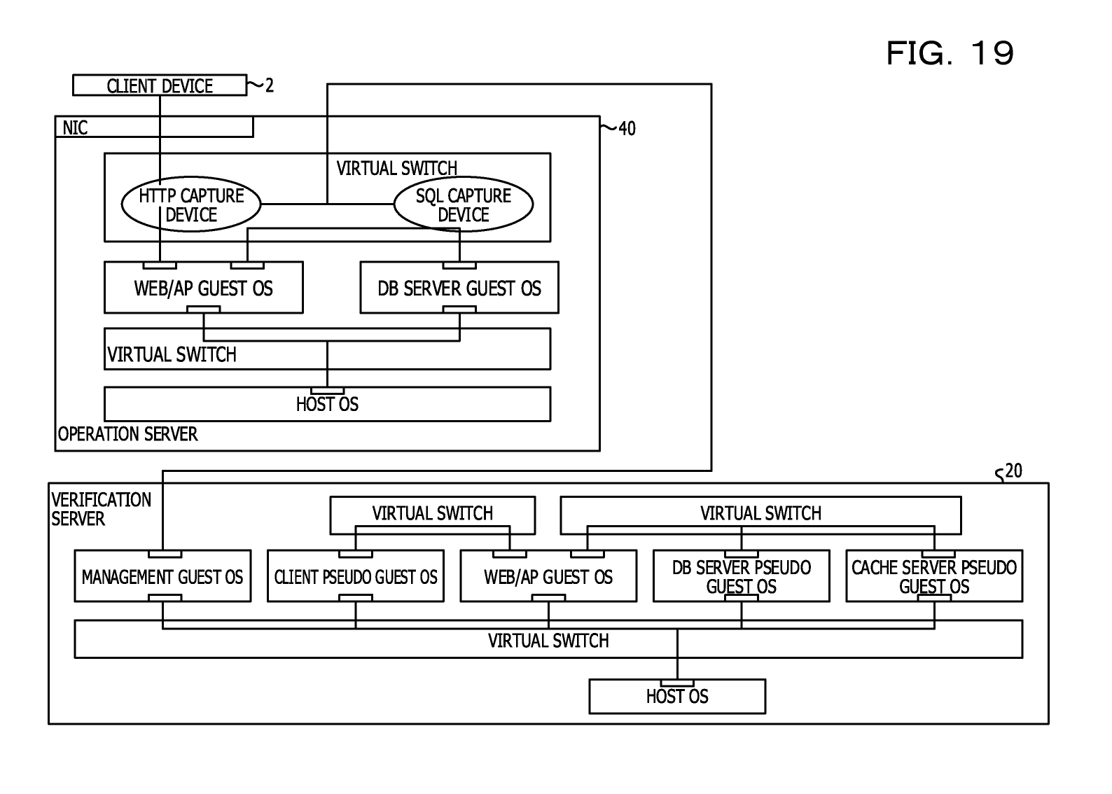

FIG. 19 is a diagram illustrating a system configuration example when an operating system and a verification system are realized to be a virtual machine on different physical servers. As illustrated in FIG. 19, the operation server 40 has the same configuration as described in FIG. 18. The verification server 20 has the same configuration as described in FIG. 17.

As illustrated in FIG. 19, by realizing both systems to be a virtual machine, the time synchronization between the HTTP capture and the SQL capture becomes easy, and the collection of capture data becomes easy. Moreover, since it is possible to reduce the number of physical servers for verification, cost can be cut down. By realizing both systems to be a virtual machine, it is possible to execute verification processing without preparing a physical server for verification. Thus, it is possible to simply execute verification processing whenever processing of an AP server or processing of a DB server is changed. Accordingly, it is possible to follow a bottleneck according to a change in a configuration of each server, and to extract an optimum cache condition.

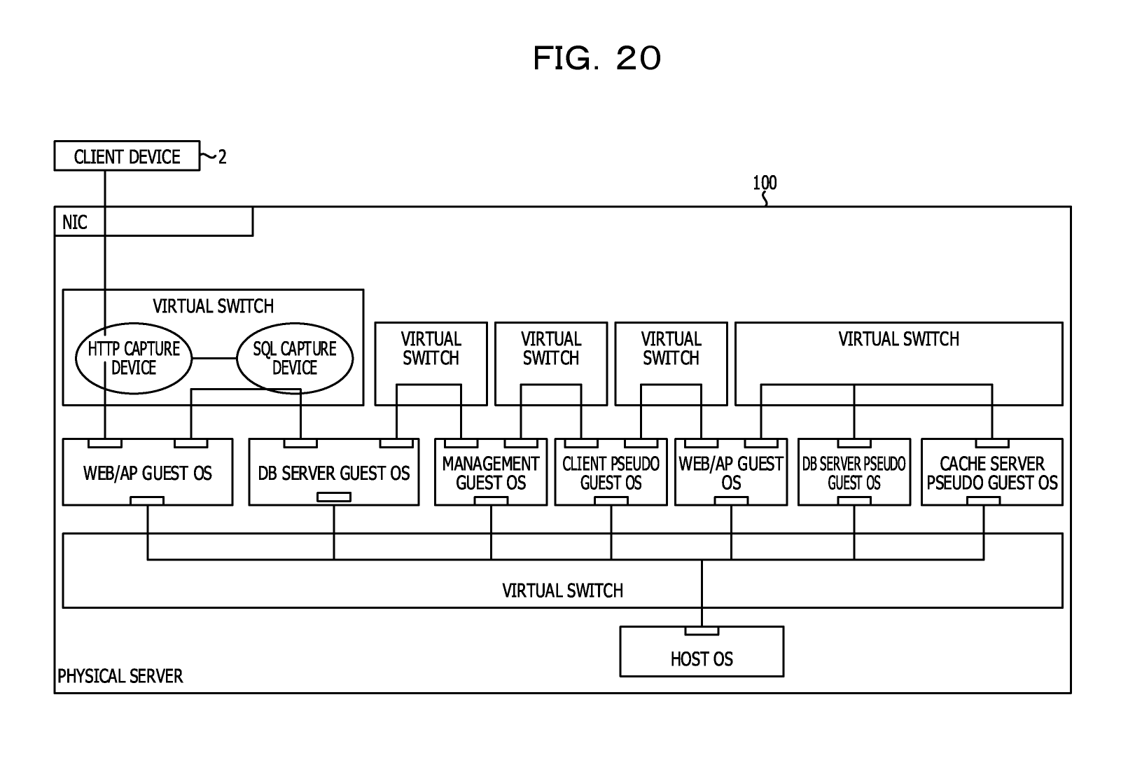

FIG. 20 is a diagram illustrating a system configuration example when the operating system and the verification system are realized to be a virtual machine on an identical physical server. As illustrated in FIG. 20, a physical server 100 operates each guest OS of the operation server 40 described in FIG. 18 and each guest OS of the verification server 20 described in FIG. 17. An operation of each guest OS is the same as described above.

As illustrated in FIG. 20, by realizing both systems to be a virtual machine of the same physical server, reduction of physical resources can be realized. It is possible to operate all the time the virtual machine of the verification system 10 in a range not affecting the operating system when there is a room for processing capability in an operating system and the like. As a result, verification of a cache server is easy. Therefore, even after introduction of the cache server, it is possible to execute verification processing according to processing loads and the like of each server, and to execute improvement of a memory capacity of the cache server or improvement and the like of the virtual processor.

### Embodiment 4

The embodiment can be implemented in a variety of different forms except Embodiments 1 to 3. Hereinafter, Embodiment 4 will be described.

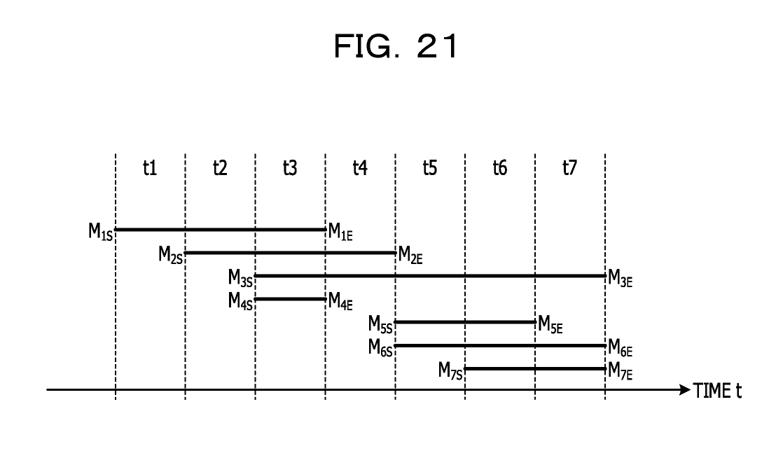

FIG. 21 is a diagram illustrating an estimate of memory capacity of the cache server. As illustrated in FIG. 21, the verification execution unit 25 of the verification server 20 determines multiplicity of a message which executes reading and writing of data.

In a case of FIG. 21, the verification execution unit 25 detects that a message M_{1S} is generated at time t1 and finished at time t3. The verification execution unit 25 detects that a message M_{2S} is generated at time t2 and finished at time t4. The verification execution unit 25 detects that a message M_{3S} is generated at time t3 and finished at time t7.

The verification execution unit 25 detects that a message M_{4S} is generated at time t3 and finished within the time. The verification execution unit 25 detects that a message M_{5S} is generated at time t5 and finished at time t6. The verification execution unit 25 detects that a message M_{6S} is generated at time t5 and finished at time t7. The verification execution unit 25 detects that a message M_{7S} is generated at time t6 and finished at time t7.

As a result, the verification execution unit 25 detects that four messages are in progress at time t3 and t6. Thus, when setting a capacity of one message to be M, the verification execution unit 25 can determine a minimum capacity of a cache memory as 4M. Thus, it is possible to determine a lower limit of the cache memory capacity and to avoid an error and the like caused by a lack of an estimate of a memory.

In the embodiments, data reading from the cache server is described as an example; however, data writing into the cache server can be also processed in the same manner.

Among respective processing described in the present embodiment, all or a portion of processing described as being performed automatically can be performed manually. Alternatively, all or a portion of processing described as being performed manually can be performed automatically in a well-known method. Besides, information which includes a processing procedure, a control procedure, a specific name, various types of data, or a parameter illustrated in the document or the drawings described above can be arbitrarily changed unless specified.

Each configuration element of each device illustrated is functionally conceptual, and is not necessarily physically configured as illustrated. That is, a specific form of dispersion or integration of each device is not limited to a form illustrated. That is, it is possible to perform a configuration by functionally or physically dispersing or integrating all or a portion of each device in an arbitrary unit according to various types of loads or a use state. Furthermore, all or any portion of each processing function performed in each device is realized by a CPU or a program interpretatively executed by the CPU, or is realized as hardware using wired logic to be obtained. For example, the HTTP capture device 5 or the SQL capture device 6 may be included in the verification server 20.

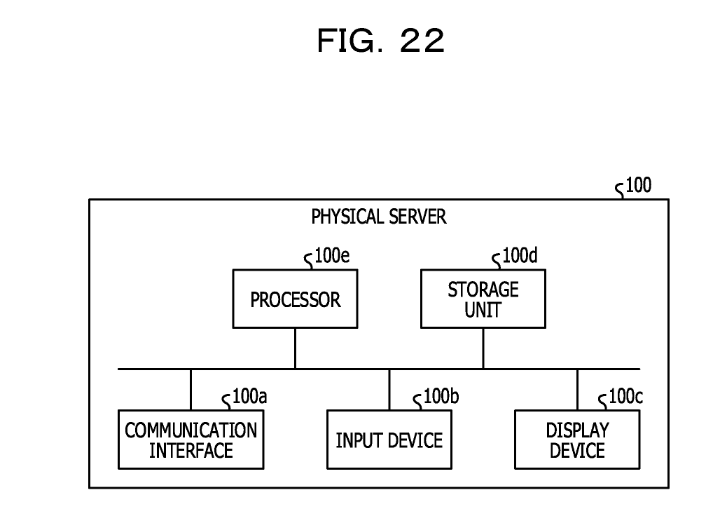

FIG. 22 is a diagram illustrating a hardware configuration example. The hardware configuration example illustrated herein is a configuration example of each server described in FIG. 1, and is described as a physical server 100 herein.

As illustrated in FIG. 22, the physical server 100 includes a communication interface 100a, an input device 100b, a display device 100c, a storage unit 100d, and a processor 100e. The hardware configuration illustrated in FIG. 22 is an example, and may have other hardware.

The communication interface 100a is an interface which establishes a communication path between the communication interface and another device to execute transmission and reception of data. The communication interface 100a is, for example, a network interface card, a wireless interface, or the like.

The input device 100b is a device which receives an input from a user and the like. The input device 100b is, for example, a mouse, a keyboard, or the like. The display device 100c is a display which displays various types of information, a touch panel, or the like.

The storage unit 100d is a storage device which stores data or various programs for executing various functions of each server. For example, the storage unit 100d stores information the same as each DB described in FIG. 2. The storage unit 100d is, for example, a ROM, a RAM, a hard disk, and the like.

The processor 100e uses a program or data stored in the storage unit 100d to control processing as each server. The processor 100e is, for example, a CPU, a MPU, or the like. The processor 100e expands a program stored in a ROM and the like in a RAM to execute various processes corresponding to various processing. For example, the processor 100e operates a process of executing the same processing as each processing unit illustrated in FIG. 2 does.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A verification method of an effect caused by introduction of a server, comprising:
storing a plurality of cache scenarios in which combinations of one or more data which are a caching object are defined, the caching object indicating an object to be stored in a first server whose processing speed is faster than that of a second server, the combinations being different from each other;
acquiring a plurality of packets related to a request for data;
estimating, by a processor, response time, which is response time to the request when using both the first server and the second server together for processing the plurality of packets, the response time corresponding to each of one or more cache scenarios among the plurality of cache scenarios, based on the plurality of cache scenarios and the plurality of acquired packets; and
specifying a cache scenario which satisfies a predetermined threshold among the one or more cache scenarios based on the estimated response time.

2. The verification method according to claim 1, further comprising:
verifying an effect caused by introduction of the second server for processing the one or more data based on the specified cache scenario; and
causing a display device to output the verified effect.

3. The verification method according to claim 1, further comprising:
storing information in which a type of data and a measured value of response time are correlated with each other; and
setting time for reading the data to be cached from the second server;
wherein the estimating includes:
determining a theoretical value of response time to each of the plurality of data based on the measured value and the reading time; and
estimating response time corresponding to each of the one or more cache scenarios based on the theoretical value.

4. The verification method according to claim 3,
wherein the determining of the theoretical value includes:
determining the theoretical value based on the reading time when object data among the plurality of data is the data to be cached; and
determining a measured value corresponding to a type of the object data as the theoretical value when the object data is not the data to be cached.

5. The verification method according to claim 4,
wherein the determining of the theoretical value includes estimating response time corresponding to each of the one or more cache scenarios based on an average value of the acquired theoretical value for each request included in the one or more cache scenarios.

6. The verification method according to claim 1,
wherein the estimating includes estimating the response time to a cache scenario in which the theoretical value is equal to or less than a predetermined value among the plurality of cache scenarios.

7. The verification method according to claim 1, further comprising:
specifying the data to be cached, which corresponds to at least one of a set of data that have the response time longer than a threshold, data that have an appearance frequency higher than a threshold, and data that have a multiplicity equal to or greater than a predetermined value and a set of data which have a cache capacity equal to or greater than a predetermined value from the acquired packet; and
generating a cache scenario in which the specified data are defined.

8. The verification method according to claim 1,
wherein the estimating includes:
executing a simulation of an operation of a data base server by changing a transmission timing for a response to a request transmitted to the data base server by an application server; and
estimating the response time based on a result of the simulation.

9. The verification method according to claim 1, further comprising:
measuring start time and end time of a message for each of a plurality of messages to execute reading of data from the second server or writing to the second server;
specifying a maximum multiplicity which indicates the maximum number of messages whose processing are overlapped in a same time zone based on the start time and the end time; and
determining a memory capacity of the second server by multiplying the memory capacity per message and the specified maximum multiplicity together.

10. A verification device comprising:
a memory which stores a plurality of cache scenarios in which combinations of one or more data which are an caching object are defined, the caching object indicating an object to be stored in a first server whose processing speed is faster than that of a second server, the combinations being different from each other; and
a processor coupled to the memory and configured to:
acquire a plurality of packets related to a request for data;
estimate response time, which is response time to the request when using both the first server and the second server together and corresponds to each of one or more cache scenarios among the plurality of cache scenarios, based on the plurality of cache scenarios and the plurality of acquired packets; and
specify a cache scenario which satisfies a predetermined threshold among the one or more cache scenarios based on the estimated response time.

11. The verification device according to claim 10,
wherein the memory is configured to store information in which a type of data and a measured value of response time are correlated with each other; and
wherein the processor is configured to:
set time for reading the data to be cached from the second server;
determine a theoretical value of response time to each of the plurality of data based on the measured value and the reading time; and
estimate response time corresponding to each of the one or more cache scenarios based on the theoretical value.

12. The verification device according to claim 11,
wherein the processor is configured to:
determine the theoretical value based on the reading time when object data among the plurality of data is the data to be cached; and
determine a measured value corresponding to a type of the object data as the theoretical value when the object data is not the data to be cached.

13. The verification device according to claim 12,
wherein the processor is configured to estimate response time corresponding to each of the one or more cache scenarios based on an average value of the acquired theoretical value for each request included in the one or more cache scenarios.

14. A non-transitory computer-readable recording medium storing a program that causes a processor to execute a process, the processor coupling to a memory which stores a plurality of cache scenarios, in which combinations of one or more data which is an caching object is defined, the caching object indicating an object to be stored in a first server whose processing speed is faster than that of a second server, the combinations being different from each other, the process comprising:
acquiring a plurality of packets related to a request for data;
estimating response time, which is response time to the request when using both the first server and the second server together and corresponds to each of one or more cache scenarios among the plurality of cache scenarios, based on the plurality of cache scenarios and the plurality of acquired packets; and
specifying a cache scenario which satisfies a predetermined threshold among the one or more cache scenarios based on the estimated response time.
